(19) United States
(12) Patent Application Publication
(10) Pub. No.: US 2026/0364503 A1
(43) Pub. Date: Nov. 19, 2026

(54) LAYERED STRUCTURE FOR ELECTROSTATIC FILTRATION OF NANOSCALE PARTICLES

(71) Applicants: ANHUI UNIVERSITY OF SCIENCE AND TECHNOLOGY, Huainan (CN); THE FIRST AFFILIATED HOSPITAL OF ANHUI UNIVERSITY OF SCIENCE AND TECHNOLOGY (HUAIN, Huainan (CN); LIANYUNGANG SECOND PEOPLE'S HOSPITAL(LIANYUNGANG INSTITUTE OF CLINICALONCOLOGY), Lianyungang (CN)

(72) Inventors: Juan HU, Lianyungang (CN); Chao LU, Huainan (CN); Shengxue WANG, Lianyungang (CN); Min MU, Huainan (CN); Yaya XIE, Huainan (CN); Jun TAO, Huainan (CN); Qianwei CHEN, Huainan (CN); Hui WANG, Lianyungang (CN)

(21) Appl. No.: 19/722,666

(22) Filed: Jun. 26, 2026

Related U.S. Application Data
(63) Continuation of application No. PCT/CN2026/092787, filed on Apr. 24, 2026.

(30) Foreign Application Priority Data
Feb. 28, 2026 (CN) 202610237872.2

(51) Int. Cl. B01D 46/00; A62B 18/02; A62B 23/00; B01D 39/16; B01D 39/20; B01D 46/42; B01D 46/50; B01D 46/54; B32B 5/02; B32B 9/04; B32B 27/28; B32B 27/30; B32B 27/36

(52) U.S. Cl. CPC B01D 46/0032; A62B 18/02; A62B 23/00; B01D 39/16; B01D 39/2065; B01D 46/0001; B01D 46/4209; B01D 46/50; B01D 46/543; B32B 5/02; B32B 9/045; B32B 27/281; B32B 27/304; B32B 27/36; B01D 2239/0258; B01D 2239/0435; B01D 2239/0631; B32B 2250/05; B32B 2255/02; B32B 2255/10; B32B 2255/20; B32B 2255/26; B32B 2262/065; B32B 2307/206; B32B 2307/21; B32B 2307/724; B32B 2307/7265; B32B 2307/7376

(57) ABSTRACT

A layered structure for electrostatic filtration of nanoscale particles, from outside to inside, sequentially including an antistatic protective layer, an electrostatic adsorption layer, an insulating layer, a flexible electrode layer, a skin-compatible waterproof layer and a power supply assembly. Two poles of the power supply assembly are respectively connected to the electrostatic adsorption layer and the flexible electrode layer. The antistatic protective layer, the electrostatic adsorption layer, the insulating layer, the flexible electrode layer and the skin-compatible waterproof layer are prepared through an in-situ polymerization and vacuum filtration integrated molding process, such that no interlayer gap is formed therebetween.

### CROSS-REFERENCE TO RELATED APPLICATIONS

This application is a continuation of International Patent Application No. PCT/CN2026/092787, filed on Apr. 24, 2026, which claims the benefit of priority from Chinese Patent Application No. 202610237872.2, filed on Feb. 28, 2026. The content of the aforementioned application, including any intervening amendments thereto, is incorporated herein by reference in its entirety.

### TECHNICAL FIELD

This application relates to electrostatic filtration, and more particularly to a layered structure for electrostatic filtration of nanoscale particles.

### BACKGROUND

In the fields of air purification, water treatment, industrial precision manufacturing and medical protection, efficient filtration and removal of nanoscale particles, including nanoscale particulate matter, heavy metal ions, and harmful molecules, are important for ensuring product quality, environmental safety, and human health.

The continuous advancement of industrialization is accompanied by the emission of various pollutants, where nanoscale pollutants, such as silica dust and coal dust having particle sizes of 0.075 nm to 100 nm, have attracted increasing attention due to their adverse effects on the environment and human health. It has been reported that millions of people worldwide suffer from cardiovascular diseases and respiratory diseases each year due to the exposure to polluted air containing nanoscale particulates. Moreover, in the precision manufacturing industries such as display panel manufacturing and semiconductor manufacturing, the nanoscale particles are considered as important factors leading to yield decline, thereby resulting in significant economic losses to enterprises.

The existing layered filtration structures generally struggle with relatively low filtration efficiency for nanoscale particles and short service lives. Therefore, there is an urgent need to develop a layered structure with improved filtration performance for nanoscale particles.

### SUMMARY

An object of the present disclosure is to a layered structure for electrostatic filtration of nanoscale particles, which addresses the problems of poor filtration efficiency for nanoscale particles and a short service life associated with conventional filtration layered structures, thereby overcoming the defects of the prior art.

Technical solutions of the present disclosure are described as follows.

A layered structure for electrostatic filtration of nanoscale particles, in sequence from outside to inside, comprising:
an antistatic protective layer;
an electrostatic adsorption layer;
an insulating layer;
a flexible electrode layer;
a skin-compatible waterproof layer; and
a power supply assembly;
wherein two poles of the power supply assembly are respectively connected to the electrostatic adsorption layer and the flexible electrode layer; and
the antistatic protective layer, the electrostatic adsorption layer, the insulating layer, the flexible electrode layer and the skin-compatible waterproof layer are prepared through an in-situ polymerization and vacuum filtration integrated molding process, and there is no interlayer gap between any two adjacent layers of the antistatic protective layer, the electrostatic adsorption layer, the insulating layer, the flexible electrode layer and the skin-compatible waterproof layer.

In some embodiments, the electrostatic adsorption layer is a composite porous membrane formed by reduced graphene oxide sheets and nitrogen-doped graphene quantum dots;
the reduced graphene oxide sheets are configured to be interlaced to construct a three-dimensional interconnected skeleton framework, and has a reduction degree of 70%-80%, while retaining some oxygen-containing functional groups comprising hydroxyl groups and epoxy groups;
the nitrogen-doped graphene quantum dots are uniformly embedded in a monodispersed state at surfaces, gaps and micropore edges of the reduced graphene oxide sheets, and are in-situ blended with the reduced graphene oxide sheets via T-I stacking.

In some embodiments, the antistatic protective layer is a waterproof insulating polyvinylidene fluoride (PVDF) composite coating synergistically modified by 0.5 wt. % of nano-silica and 1 wt. % of a fluorocarbon waterproofing agent; and a surface of the antistatic protective layer is provided with micro-protrusions.

In some embodiments, the insulating layer is a waterproof polyimide (PI) film or an electrospun polylactic acid (PLA) film, having a thickness of 1-2 μm and a microporosity of greater than or equal to 70%; and the insulating layer is bonded to the electrostatic adsorption layer and the flexible electrode layer.

In some embodiments, the flexible electrode layer is a graphene-coated PI film or a carbon nanotube-coated PI film, and has a thickness of 1-1.2 μm; a middle area of the flexible electrode layer is arranged in a discontinuous pattern of dots or grids; and a continuous conductive region having a width of 5-8 mm is reserved at an edge of the flexible electrode layer.

In some embodiments, the skin-compatible waterproof layer is a waterproof cotton-blended composite film modified by 0.8 wt. % silicone waterproofing agent, and has a thickness of 2-3 μm, a volume resistivity greater than or equal to 10¹⁰ Ω·cm, and an air permeability greater than or equal to 300 mm/s under a pressure of 200 Pa.

In some embodiments, the power supply assembly comprises a flexible thin-film battery, an overcurrent protection resistor, a Zener diode and a switch;
the flexible thin-film battery, the overcurrent protection resistor, the Zener diode and the switch are connected in series through wires;
a connection between the power supply assembly and the electrostatic adsorption layer is located in an edge region of a side of the electrostatic adsorption layer away from the insulating layer; and
a connection between the power supply assembly and the flexible electrode layer is located in the continuous conductive region.

In some embodiments, the layered structure is applied to a disposable industrial electrostatic dust-removal mask;
the disposable industrial electrostatic dust-removal mask, from outside to inside, sequentially comprises: a protective fabric layer, the layered structure, a supporting mesh layer, and a skin-compatible fabric layer;
the protective fabric layer is made of polyester fibers and has a thickness of 5-8 μm;
the supporting mesh layer is made of a polyamide material, with a mesh aperture size of 100-200 μm;
the skin-compatible fabric layer is made of a cotton-blended material and has a thickness of 3-5 μm;
the skin-compatible fabric layer is distributed in a face-contacting region of a base of the disposable industrial electrostatic dust-removal mask; and
a protruding non-face-contacting filtration cavity of the disposable industrial electrostatic dust-removal mask is provided with the protective fabric layer, the layered structure and the supporting mesh layer.

In some embodiments, the layered structure is prepared through steps of:
sequentially depositing the antistatic protective layer, the electrostatic adsorption layer, the insulating layer, the flexible electrode layer and the skin-compatible waterproof layer on a filter membrane through the in-situ polymerization and vacuum filtration integrated molding process at a vacuum degree ranging from −0.09 MPa to −0.08 MPa, and a polymerization temperature of 58-62 °C for 1.5-2.5 h; and
the electrostatic adsorption layer is prefabricated via the following steps prior to the integrated molding process:
mixing a graphene oxide dispersion and nitrogen-doped graphene quantum dots at a weight ratio of 95:5 followed by ultrasonic dispersion for 25-35 min, pH adjustment to 6.3-6.7, addition of vitamin C as a reducing agent, and reduction reaction at 60 °C for 1.5-2.5 h, wherein a reduction degree is controlled to be 70-80%.

In some embodiments, the electrostatic adsorption layer is a nanocarbon fiber-electrospun PVDF composite membrane, which is prepared through steps of:
blending nanocarbon fibers and a PVDF electret at a weight ratio of 1:9 followed by electrospinning at a spinning voltage of 18-22 kV, a flow rate of 0.8-1.2 mL/h and a collection distance of 15-20 cm to form the nanocarbon fiber-electrospun PVDF composite membrane having a thickness of 12-15 μm.

Compared to the prior art, the present disclosure has the following beneficial effects.

In the present disclosure, the two poles of the power supply assembly are respectively connected to the electrostatic adsorption layer and the flexible electrode layer. The insulating layer is provided between the electrostatic adsorption layer and the flexible electrode layer. In cooperation with a slit-microporous dual-scale porous structure and high-density electrostatic micro-nodes of the electrostatic adsorption layer, uniform full-domain polarization of the electrostatic adsorption layer is achieved through voltage focusing technology without any adsorption blind zones, thereby enabling efficient and long-lasting filtration of nanoscale particles having a size of 0.075-100 nm. A mask prepared using the layered structure combines high-efficiency filtration with long-term wearing comfort, and significantly alleviates the conventional technical contradiction between high filtration efficiency and high breathing resistance in existing masks, making it suitable for long-duration industrial operations.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained based on these accompanying drawings without making creative effort.

FIG. 1 is an exploded view of a layered structure for electrostatic filtration of nanoscale particles according to Example 1 of the present disclosure;

FIG. 2 is a structural view of an electrostatic adsorption layer according to Example 1 of the present disclosure;

FIG. 3 is a structural view of a disposable industrial electrostatic dust-removal mask according to an embodiment of the present disclosure;

FIG. 4 is an internal structural view of the disposable industrial electrostatic dust-removal mask according to an embodiment of the present disclosure; and

FIG. 5 is a comparison table of Example 1, Comparative Example 1, Example 10, and Comparative Example 2 according to the present disclosure.

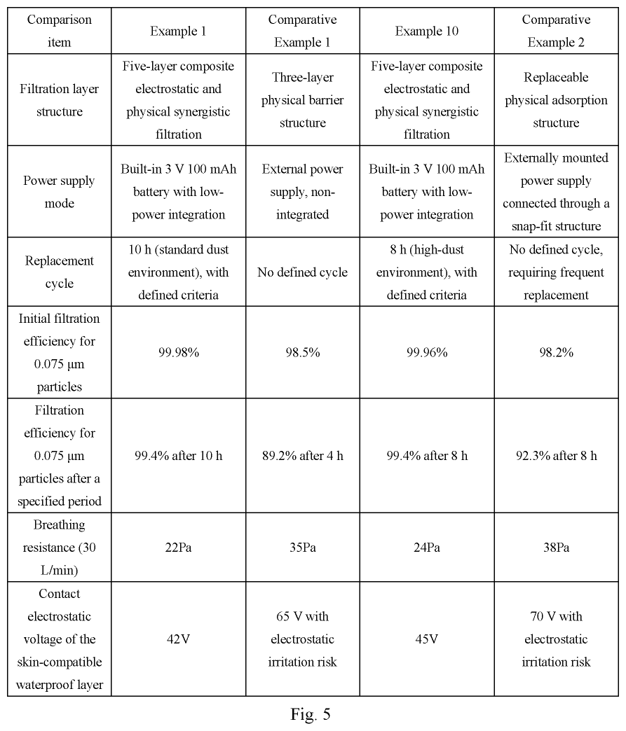

### DETAILED DESCRIPTION OF EMBODIMENTS

In order to make the objects, technical solutions and advantages of the present disclosure clearer, the present disclosure will be described clearly and completely below in conjunction with the accompanying drawings and embodiments. Obviously, described herein are merely some embodiments of the present disclosure, rather than all embodiments. Based on the embodiments in the present disclosure, all other embodiments obtained by those of ordinary skill in the art without making creative effort shall fall within the scope of the present disclosure defined by the appended claims.

An embodiment of the present disclosure provides a layered structure for electrostatic filtration of nanoscale particles, which addresses the problems of poor filtration efficiency for nanoscale particles and short service life associated with existing filtration layered structures.

In order to facilitate a better understanding of the above technical solutions, the technical solutions will be described in detail below with reference to the accompanying drawings and the embodiments.

### Example 1

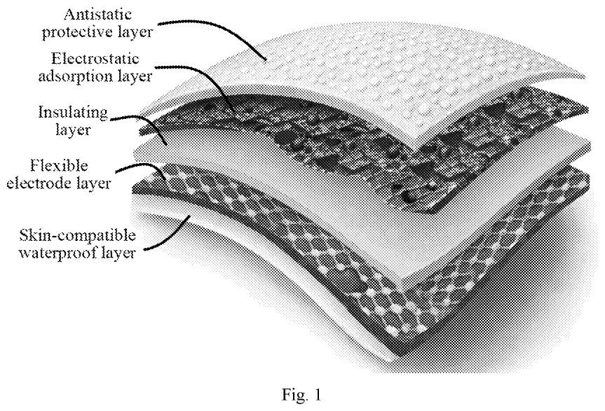

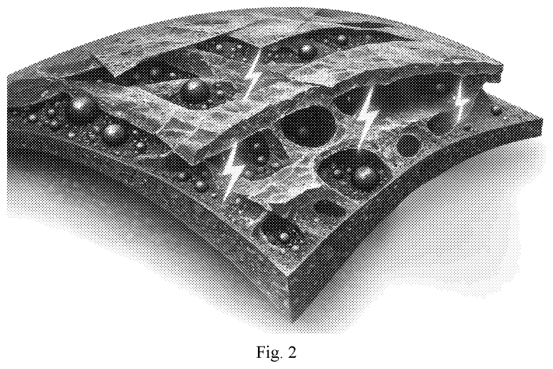

As shown in FIGS. 1-2, the present disclosure provides a layered structure for electrostatic filtration of nanoscale particles. The layered structure, in sequence from outside to inside, includes: an antistatic protective layer, an electrostatic adsorption layer, an insulating layer, a flexible electrode layer, a skin-compatible waterproof layer, and a power supply assembly.

The layered structure has a total thickness of 22 μm, and the thickness of each layer is adjustable within a range of ±0.5 μm, and has a microporosity of 65%. The layered structure is prepared through an in-situ polymerization and vacuum filtration integrated molding process at a vacuum degree of −0.085 MPa, and a polymerization temperature of 60 °C for 2 h, and there is no interlayer gap between any two adjacent layers of the antistatic protective layer, the electrostatic adsorption layer, the insulating layer, the flexible electrode layer and the skin-compatible waterproof layer. Accordingly, a triple-protection structure having an outer waterproof and wear-resistant region, a middle insulating and antistatic region, and an inner waterproof and skin-compatible region is formed while ensuring electric-field penetrability and airflow smoothness. Compared with existing layered splicing-type filtration structures, the layered structure exhibits enhanced structural stability and functional synergy.

The in-situ polymerization process is performed according to the relevant methods set forth in the Organisation for Economic Co-operation and Development (OECD) Guidance on Sample Preparation and Dosimetry for Manufactured Nanomaterials (2025 Edition). Using a JH-1000 composite membrane performance tester, a bubble content is measured by microscopic observation to be less than 1%. Meanwhile, a micropore uniformity of 98.2%±0.3%, a reaction completion rate of 99%, an interlayer bonding strength of 5.8 N/10 mm, a curing degree of 99%, a reduced graphene oxide (rGO) sheet distribution uniformity of greater than or equal to 95% (measured as 95%±0.5%), and a folding endurance of 510±12 cycles are obtained. The layered structure satisfies the health and safety protection principal requirements for nanomaterial operating environments specified in GB/T 33715-2025 Nanotechnologies—Health and safety practices in occupational settings, and can sufficiently meet long-term industrial operation protection stability requirements.

Two poles of the power supply assembly are respectively connected to the electrostatic adsorption layer and the flexible electrode layer.

The antistatic protective layer is a waterproof insulating polyvinylidene fluoride (PVDF) composite coating synergistically modified by 0.5 wt. % of nano-silica and 1 wt. % of a fluorocarbon waterproofing agent. Since waterproof modification of PVDF coating materials belongs to conventional technical means in the art, detailed description thereof is omitted herein. The antistatic protective layer has a thickness of 1.5 μm. Abrasion resistance testing is conducted according to the currently effective national standard GB/T 21196.2-2007. To accommodate a textile substrate material of the antistatic protective layer, a YG(B)401E Martindale abrasion tester is employed under testing conditions including a friction load of 9 N, a pure cotton fabric as the abrading medium, and a standard environment of 20±2 °C and 65±5% RH. The antistatic protective layer exhibits an abrasion resistance of greater than or equal to 500 cycles and a volume resistivity of greater than or equal to 10¹² Ω·cm, thereby achieving triple protection including prevention of electrostatic breakdown, prevention of external water penetration, and prevention of large-particle dust from clogging the electrostatic adsorption layer. The surface of the antistatic protective layer is provided with micro-protrusions having a protrusion height of 0.9 μm to facilitate removal of attached dust and prolong the service life of the filtration layer. Under an extreme industrial environment simulated using an SH-261 constant temperature and humidity chamber at 85% RH and −5 °C for 72 h, attenuation of the volume resistivity does not exceed 20%, and no short-circuit or leakage phenomenon occurs, thereby overcoming instability problems of existing protective layers under complex environmental conditions.

As shown in FIG. 2, the electrostatic adsorption layer has a thickness of 13.5 μm, and is a composite porous membrane formed by reduced graphene oxide sheets and nitrogen-doped graphene quantum dots (rGO/N-GQDs). The reduced graphene oxide (rGO) sheets are configured to be interlaced to construct a three-dimensional interconnected skeleton framework. The graphene sheets have a thickness of 1.5 nm, a reduction degree of 70%-80%, while retaining some oxygen-containing functional groups including hydroxyl groups and epoxy groups, thereby precisely balancing skeleton stability, micropore connectivity, and moderate electrical conductivity to avoid rapid electrostatic dissipation. The nitrogen-doped graphene quantum dots (N-GQDs) are uniformly embedded in a monodispersed state at surfaces, gaps, and micropore edges of the reduced graphene oxide sheets, and are in-situ blended with the reduced graphene oxide sheets via T-stacking to form high-density electrostatic micro-nodes having node spacings of 20-50 nm, thereby providing stable structural support for a uniform electrostatic field.

The insulating layer is a waterproof polyimide (PI) film, having a thickness of 1.5 μm and a microporosity of greater than or equal to 70%. The insulating layer is bonded to the electrostatic adsorption layer and the flexible electrode layer, thereby completely preventing short-circuiting between two electrodes and effectively blocking water vapor penetration. The insulating layer ensures electric-field penetrability without increasing airflow resistance, is adaptable to humid industrial environments, and addresses problems of excessive thickness and poor air permeability associated with existing insulating layers.

The flexible electrode layer is a graphene-coated polyimide (PI) film having a thickness of 1.1 μm. A middle area of the flexible electrode layer is arranged in a discontinuous pattern of dots or grids. A continuous conductive region having a width of 5-8 mm is reserved only at an edge of the flexible electrode layer for connection with a wire of the power supply assembly. The discontinuously distributed middle area avoids blockage of adsorption channels and ensures smooth airflow, while enabling a positive electric field to uniformly diffuse outwardly so as to achieve full-domain polarization of the electrostatic adsorption layer without adsorption blind zones, thereby overcoming defects of existing continuous electrode layers including easy blockage and uneven electric-field distribution.

The skin-compatible waterproof layer is a waterproof cotton-blended composite film modified by 0.8 wt. % silicone waterproofing agent. Since waterproof modification of the skin-compatible waterproof layer belongs to conventional technical means in the art, detailed description thereof is omitted herein. The skin-compatible waterproof layer provides both softness and skin friendliness as well as insulating waterproof properties. The skin-compatible waterproof layer has a thickness of 2.5 μm and a volume resistivity of greater than or equal to 10¹⁰ Ω·cm. Air permeability testing is conducted according to the currently effective standard GB/T 5453-1997 (adapted for a fabric material of the skin-compatible waterproof layer), with a target air permeability of greater than or equal to 300 mm/s. Using an LFY-216 fabric air permeability tester under a test pressure of 200 Pa in an environment of 20±2 °C and 65±5% RH, three samples are tested and the average measured air permeability is 320 mm/s. This result directly supports the rationale for a thickness of 2.5 μm for the skin-compatible waterproof layer, ensuring that the air permeability meets the requirement while avoiding insufficient waterproofing due to inadequate thickness or poor air permeability due to excessive thickness. Skin irritation testing is conducted according to the currently effective national standard GB/T 16175-2008 (adapted to skin-contact protective materials). A 24-hour patch test is conducted on 10 healthy subjects (5 males and 5 females, aged 20-45 years), with a target irritation level of 0. All subjects are measured as grade 0 (no irritation), and no redness, swelling, itching, or other phenomena are observed. This result directly supports the rationale for the selection of the skin-compatible waterproof layer material, ensuring no discomfort during long-term contact with the face, and making it suitable for prolonged industrial wear. Contact electrostatic voltage testing is conducted with a target contact electrostatic voltage of less than or equal to 50 V using an EST101 electrostatic voltage tester under a standard environment. A measured average voltage is 42 V. The result directly demonstrates suitability of insulating properties of the skin-compatible waterproof layer, thereby avoiding physical discomfort or electrostatic interference caused by electrostatic accumulation. The skin-compatible waterproof layer has a contact electrostatic voltage of less than or equal to 50 V, thereby effectively blocking water vapor from penetrating into the flexible electrode layer to avoid electrode short-circuiting or leakage caused by water vapor while preventing static electricity from directly contacting skin.

The electrostatic adsorption layer adopts a dual-stage porous structure including slit structures and microporous, thereby balancing airflow resistance and adsorption efficiency. Interlaced reduced graphene oxide sheets form micron-scale interconnected slits having aperture sizes of 0.5-1 μm and occupying 20%-30% of an area of the composite porous membrane, the slits serving as primary airflow channels to maintain airflow resistance at less than or equal to 25 Pa. Micropores in a nano-to-submicron size range and having aperture sizes of 50-200 nm are distributed within and at connection regions of the reduced graphene oxide sheets and occupy 40%-50% of the area of the composite porous membrane. The micropores are interconnected with the slits to form a three-dimensional adsorption network, thereby increasing adsorption area and achieving a filtration efficiency of greater than or equal to 99.95% for particles having a particle size of 0.075 μm. High electric-field regions having field strengths of 10-20 kV/m are formed at edges of the slits due to aggregation of reduced graphene oxide sheets. Voltage focusing is achieved through the grid-shaped configuration of the flexible electrode layer and the high dielectric properties of the electrostatic adsorption layer. An effective voltage applied to the electrostatic adsorption layer is generated by reducing a voltage from a 3 V battery through a Zener diode and subsequently distributing the voltage through the electrode layer, thereby precisely polarizing nanoscale particles to achieve high-efficiency electrostatic adsorption. In combination with physical interception mechanisms, filtration performance is further enhanced. Filtration efficiency testing is conducted according to the currently effective national standard GB 2626-2019 using a TSI-8130 particulate filtration efficiency tester under testing conditions including an airflow rate of 30 L/min and a standard dust concentration of 10 mg/m³ using ISO 12103-1 A1 ultrafine dust. A filtration efficiency target of greater than or equal to 99.95% is set. Measured filtration efficiencies for particles having different particle sizes are as follows: filtration efficiency for particles having a particle size of 0.075 μm is greater than or equal to 99.95%; filtration efficiency for particles having a particle size of 0.1 μm is greater than or equal to 99.94%; filtration efficiency for particles having a particle size of 0.3 μm is greater than or equal to 95%; filtration efficiency for particles having a particle size of 1 μm is greater than or equal to 99.98%; and filtration efficiency for particles having a particle size of 10 μm is greater than or equal to 99.99%, thereby forming a complete particle-size/filtration-efficiency protection profile. Saturated adsorption capacity is 1.35 mg/cm² based on a membrane thickness of 13.5 μm. Decay of electric-field strength over time is strictly controlled within a reasonable range. Measurements obtained using an electric-field strength meter indicate that electric-field strength values are 12-12.5 kV/m after 8 hours and 10-10.3 kV/m after 10 hours, with corresponding filtration efficiencies maintained at 99.5% and 99.4%, respectively, demonstrating electrostatic durability significantly superior to that of existing electret materials.

The power supply assembly includes a flexible thin-film battery, an overcurrent protection resistor, a Zener diode and a switch.

The flexible thin-film battery, the overcurrent protection resistor, the Zener diode, and the switch are connected in series through wires.

A connection between the power supply assembly and the electrostatic adsorption layer is located in an edge region of a side of the electrostatic adsorption layer away from the insulating layer. A connection between the power supply assembly and the flexible electrode layer is located in the continuous conductive region.

The flexible thin-film battery is a 3 V, 100 mAh lithium-ion micro flexible thin-film battery. The battery is encapsulated with an epoxy resin coating having a coating thickness of less than or equal to 100 μm, thereby adapting to industrial environments having high humidity and high dust concentrations. A circuit operating current is less than or equal to 5 mA, thereby enabling continuous power supply for more than 10 hours.

The overcurrent protection resistor has a resistance value of 180 Ω and a rated current of 50 mA. When a fault current in the circuit exceeds 50 mA, the overcurrent protection resistor limits the current to a safe range, thereby preventing damage to the power supply assembly and ensuring operational safety.

The Zener diode is a 2.7 V Zener diode matched with a 3 V flexible thin-film battery. The voltage is reduced and then distributed and focused through a grid-shaped structure of the flexible electrode layer and transmitted to two electrodes. Under triple protection of the antistatic protective layer, the insulating layer, and the skin-compatible waterproof layer, external and internal water vapor or liquid is effectively blocked, thereby preventing short-circuiting or leakage of the electrodes. A stable directional electrostatic field is formed, and the electric field penetrates the insulating layer to enable full-domain polarization of the rGO/N-GQDs composite membrane in the electrostatic adsorption layer, ensuring that the electrostatic field strength is maintained at 10-20 kV/m within 8-10 hours and that the filtration efficiency is maintained at greater than or equal to 99.4%.

Electrical safety testing of the power supply assembly is conducted according to the currently effective standards GB 4943.1-2022 and GB 31241-2022 (adapted respectively for portable electrical components and lithium-ion batteries). A testing objective is set that overcharge, over-discharge, short-circuit, and temperature rise all meet standard requirements. All test items are found to comply with the standards, and the results directly support the reasonableness of the 3 V/100 mAh battery and the 180 Ω/50 mA protection resistor, thereby ensuring electrical safety and stable operation of the circuit and preventing electrical failures. In a short-circuit protection test, a target fusing current of 50 mA is set. A short-circuit fault is manually simulated and monitored using a CH260 power consumption tester. The measured average fusing current is 50 mA, and automatic fusing occurs when the current exceeds 50 mA. This result directly supports the rationale for selecting a 180 Ω protection resistor, ensuring that the power supply can be promptly cut off in the event of a short circuit, thereby protecting both the circuit and the filtration structure. In a power supply duration test, a target of greater than or equal to 10 h is set. Under a normal operating current of 4.8 mA (measured value), testing is conducted using a CH260 circuit power consumption tester. The measured average power supply duration is 20.8 h, thereby directly supporting the rationale of the 100 mAh battery capacity and satisfying industrial single-operation requirements of greater than or equal to 10 h while avoiding frequent replacement due to insufficient capacity.

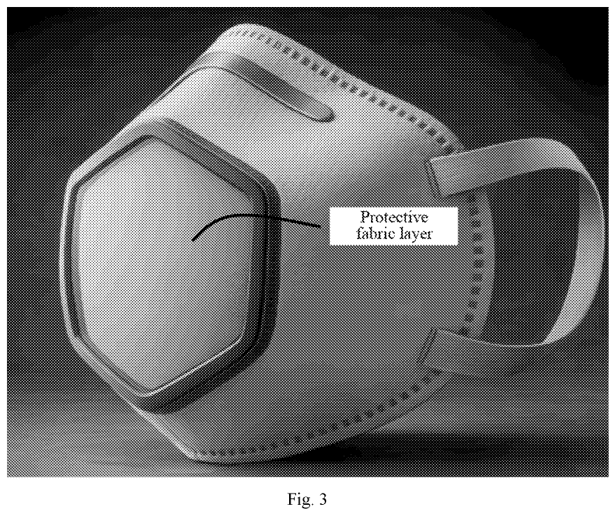

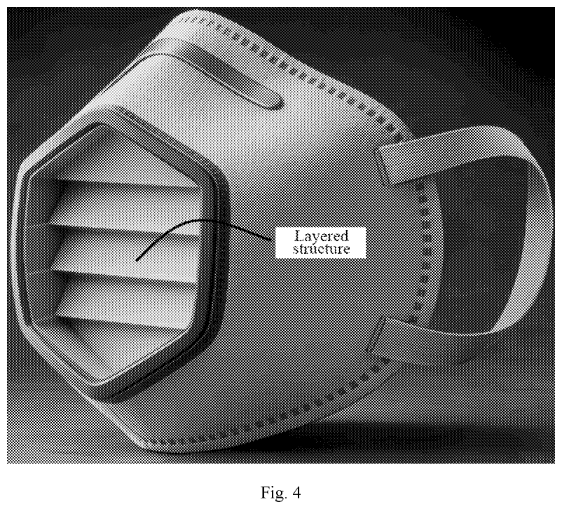

As shown in FIGS. 3-4, the layered structure is applied to a disposable industrial electrostatic dust-removal mask. The disposable industrial electrostatic dust-removal mask, from outside to inside, sequentially includes: a protective fabric layer, the layered structure, a supporting mesh layer, and a skin-compatible fabric layer.

The outer protective layer is made of polyester fibers and has a thickness of 6.5 μm, and is used to preliminarily block dust particles having a particle size of greater than or equal to 1 μm, thereby preventing premature clogging of the layered structure. The supporting mesh layer is made of a polyamide material, with a mesh aperture size of 100-200 μm, and exhibits excellent mechanical strength and deformation adaptability, thereby stably supporting the layered structure and preventing structural deformation failure. The skin-compatible layer is made of a cotton-blended material and has a thickness of 4 μm, and is distributed only in a face-contacting region of a base of the disposable industrial electrostatic dust-removal mask, providing breathable and non-irritating contact. A protruding non-face-contacting filtration cavity of the disposable industrial electrostatic dust-removal mask is provided only with the protective fabric layer, the layered structure, and the supporting mesh layer, and is not provided with the skin-compatible fabric layer, thereby ensuring that airflow directly enters a filtration system and preventing reduced filtration efficiency caused by airflow bypass. Edges of the protective fabric layer, the supporting mesh layer, and the skin-compatible fabric layer are heat-sealed together with the filtration cavity region to form an integral unit (heat pressing temperature: 120 °C, pressure: 0.3 MPa, time: 10 s), thereby forming a complete disposable mask contour. A facial contact pressure is less than or equal to 1.5 kPa, enabling precise adaptation to a human facial contour and ensuring long-term wearing fit, thereby solving problems of mask loosening and airflow leakage in conventional masks.

The layered structure is prepared through the following steps.

The antistatic protective layer, the electrostatic adsorption layer, the insulating layer, the flexible electrode layer and the skin-compatible waterproof layer are sequentially deposited on a filter membrane through the in-situ polymerization and vacuum filtration integrated molding process at a vacuum degree of −0.085 MPa, and a polymerization temperature of 60 °C for 2 h.

The electrostatic adsorption layer is prefabricated via the following steps prior to the integrated molding process.

A graphene oxide dispersion and nitrogen-doped graphene quantum dots are mixed at a weight ratio of 95:5, followed by ultrasonic dispersion for 30 min, pH adjustment to 6.5, addition of vitamin C as a reducing agent, and reduction reaction at 60 °C for 2 h, where a reduction degree is controlled to be 70-80%.

In this embodiment, an electric-field meter is used to measure that an initial electric-field strength of the electrostatic adsorption layer is 18 kV/m, which decreases to 12.5 kV/m after 8 h and to 10.3 kV/m after 10 h. The initial filtration efficiency for particles having a size of 0.075 μm is 99.98%, for particles having a size of 0.1 μm is 99.96%, for particles having a size of 0.3 μm is 99.9%, for particles having a size of 1 μm is 99.99%, and for particles having a size of 10 μm is 99.99%. After 8 h, the filtration efficiency for particles having the size of 0.075 μm is 99.5%, and after 10 h, the filtration efficiency for particles having the size of 0.075 μm is 99.4%.

In this embodiment, the disposable industrial electrostatic dust-removal mask exhibits a breathing resistance of 22 Pa at an airflow rate of 30 L/min and a ventilation capacity of 32 L/min, thereby providing comfortable wearing without a sense of suffocation. A contact electrostatic voltage of the skin-compatible waterproof layer is 42 V, thereby eliminating electrostatic irritation risk at a fundamental level. Under extreme conditions of 85% RH and −5 °C, a volume resistivity attenuation of the insulating layer and other layers having electrical insulating properties is 15%, and no short-circuit or leakage phenomenon occurs. In a standard dust environment with a dust concentration of 10 mg/m³, the mask shows good adaptability, and an adsorption capacity after 10 h remains below 80% of a saturation capacity, with no risk of clogging, thereby enabling long-term industrial operation. The filtration durability is significantly superior to that of conventional electret N95 masks.

### Example 2

The difference from Example 1 is that the vacuum degree in the in-situ polymerization process is −0.08 MPa. Using the same testing method as in Example 1, a bubble content of 5% is measured.

### Example 3

The difference from Example 1 is that the vacuum degree in the in-situ polymerization process is −0.09 MPa. Using the same testing method as in Example 1, a micropore blockage rate of 12% is measured.

Example 4

The difference from Example 1 is that the polymerization temperature in the in-situ polymerization process is 55 °C. Using the same testing method as in Example 1, the reaction completion rate of 82% and the interlayer bonding strength of 3.2 N/10 mm are measured.

### Example 5

The difference from Example 1 is that the polymerization temperature in the in-situ polymerization process is 65 °C. Using the same testing method as in Example 1, an rGO aggregation rate of 15% and an electrostatic node failure rate of 8% are measured.

### Example 6

The difference from Example 1 is that the holding time in the in-situ polymerization process is 1.5 h. Using the same testing method as in Example 1, the degree of curing of 85% is measured.

### Example 7

The difference from Example 1 is that the holding time in the in-situ polymerization process is 2.5 h. Using the same testing method as in Example 1, a film embrittlement rate of 10% is measured.

### Example 8

The difference from Example 1 is that the insulating layer is an electrospun polylactic acid (PLA) film.

### Example 9

The difference from Example 1 is that the flexible electrode layer is a carbon nanotube-coated polyimide (PI) film.

### Example 10

The difference from Example 1 is that the electrostatic adsorption layer is a nanocarbon fiber-electrospun PVDF composite membrane, specifically adapted for high-dust environments. The nanocarbon fibers form a three-dimensional conductive network to uniformly distribute an electric field and increase adsorption sites, thereby avoiding electret failure caused by excessive local electric fields while enhancing mechanical strength of the membrane. The PVDF electret achieves long-term electrostatic storage through dipole orientation, and the nanocarbon fibers and the PVDF electret synergistically improve adsorption capacity and stability. The electrostatic adsorption layer is prepared by blending nanocarbon fibers and the PVDF electret at a weight ratio of 1:9 followed by electrospinning at a spinning voltage of 20 kV, a flow rate of 1 mL/h, and a collection distance of 17.5 cm, thereby forming the nanocarbon fiber-electrospun PVDF composite membrane having a thickness of 13.5 μm. In a high-dust environment having a dust concentration of 25 mg/m³, a filtration efficiency attenuation rate is 15% slower than that of a primary substrate material, and production cost is reduced, thereby providing diversified options for industrial implementation and expanding applicable scenarios. Based on a membrane thickness reference of 13.5 μm, the electrostatic adsorption layer has a saturated adsorption capacity of 1.35 mg/cm² and an adsorption capacity per unit thickness of 0.1 mg/cm²·μm. Measurements obtained using an electric-field meter indicate that an initial electric-field strength is 16 kV/m and decreases to 10.5 kV/m after 8 h. Initial filtration efficiencies are as follows: a filtration efficiency for particles having a size of 0.075 μm is 99.96%; a filtration efficiency for particles having a size of 0.1 μm is 99.94%; a filtration efficiency for particles having a size of 0.3 μm is 99.8%; a filtration efficiency for particles having a size of 1 μm is 99.98%; and a filtration efficiency for particles having a size of 10 μm is 99.99%. After 8 h, the filtration efficiency for particles having the size of 0.075 μm is 99.4%, thereby satisfying protection requirements in high-dust environments.

In this embodiment, the disposable industrial electrostatic dust-removal mask exhibits a breathing resistance of 24 Pa and a ventilation capacity of 31 L/min at an airflow rate of 30 L/min, thereby providing good wearing comfort. A contact electrostatic voltage of the skin-compatible waterproof layer is 45 V, thereby eliminating risks of electrostatic irritation. Under extreme conditions of 85% RH and 5 °C, a volume resistivity attenuation of the insulating layer and other layers having electrical insulating properties is 18%, and no short-circuit or leakage phenomenon occurs. Stable performance is maintained in a high-dust environment having a dust concentration of 25 mg/m³. After 8 h of operation, the adsorption capacity reaches 75% of a saturation capacity, and no clogging, short-circuit, or electrostatic leakage phenomenon occurs, thereby enabling a replacement cycle that matches design requirements and providing cost-performance advantages.

### Example 11

The difference from Example 1 is that the electrostatic adsorption layer has a thickness of 15 μm corresponding to an upper thickness limit of a primary substrate material. The power supply assembly employs a 3 V, 100 mAh lithium-ion micro flexible thin-film battery, with a supply voltage adjusted to 2.8 V corresponding to a lower voltage limit of the battery and a working current of 4.5 mA. The mask has a total thickness of 22 μm and a face-contact pressure of 1.5 kPa.

Measurements obtained using an electric-field meter indicate that an initial electric-field strength of the electrostatic adsorption layer is 10.2 kV/m, which decreases to 9.8 kV/m after 8 h and to 9.5 kV/m after 10 h. The initial filtration efficiency for particles having a size of 0.075 μm is 99.97%, which is maintained at 99.4% after 8 h and decreases to 99.3% after 10 h, thereby reaching a replacement threshold value.

In this embodiment, the disposable industrial electrostatic dust-removal mask exhibits a breathing resistance of 25 Pa corresponding to a threshold value and a leakage rate of 8% at an airflow rate of 30 L/min. A contact electrostatic voltage of the skin-compatible waterproof layer is 48 V. In a standard dust environment having a dust concentration of 10 mg/m³, the adsorption capacity reaches 80% of a saturation capacity after 10 h, thereby triggering a replacement mechanism.

### Comparative Example 1

A conventional industrial dust mask includes a filtration layer having a three-layer physical barrier structure without an electrostatic adsorption layer, where a power supply assembly is externally disposed and no defined replacement cycle is provided. Testing conditions include a dust concentration of 10 mg/m³ and an airflow rate of 30 L/min. Test results indicate that an initial filtration efficiency for particles having a size of 0.075 μm is 98.5%, which decreases to 89.2% after 4 h. A filtration efficiency for particles having a size of 0.3 μm is 94.8%. A breathing resistance is 35 Pa, a face-contact pressure is 2.0 kPa, and a contact electrostatic voltage of the skin-compatible waterproof layer is 65 V. No defined replacement cycle is provided.

### Comparative Example 2

A conventional electrostatic filtration mask includes a replaceable physical adsorption structure as a filtration layer, where the power supply assembly is externally mounted and connected through a snap-fit structure and no defined replacement cycle is provided. Testing conditions include a dust concentration of 25 mg/m³ and an airflow rate of 30 L/min. Test results indicate that an initial filtration efficiency for particles having a size of 0.075 μm is 98.2%, which decreases to 92.3% after 8 h. A filtration efficiency for particles having a size of 0.3 μm is 94.5%. A breathing resistance is 38 Pa, a facial-contact pressure is 2.2 kPa, and a contact electrostatic voltage of the skin-compatible waterproof layer is 70 V. After 8 h, the adsorption capacity reaches 90% of a saturation capacity, thereby requiring frequent replacement.

Compared to the prior art, the present disclosure has the following beneficial effects.

1. Regarding the layered structure of the present disclosure, two poles of the power supply assembly are respectively connected to the electrostatic adsorption layer and the flexible electrode layer, and an insulating layer is provided between the electrostatic adsorption layer and the flexible electrode layer. In cooperation with the slit-micropore dual-stage porous structure and high-density electrostatic micro-nodes of the electrostatic adsorption layer, full-domain uniform polarization of the electrostatic adsorption layer without adsorption blind zones is achieved through a voltage-focusing technique, thereby enabling efficient and long-lasting filtration of nanoscale particles having sizes of 0.075-100 nm. A mask prepared using the layered structure provides both high filtration efficiency and long-term wearing comfort, thereby significantly alleviating the technical contradiction in existing masks between high filtration efficiency and high breathing resistance and satisfying requirements for long-duration industrial operations.

2. In this embodiment, the layered structure provides comprehensive protection from an outer side, an intermediate region, and an inner side through a triple-protection structure including an antistatic protective layer, an insulating layer, and a skin-compatible waterproof layer, thereby blocking penetration of external water and internal water vapor, avoiding electrode short circuits or leakage, and reducing risks of electrostatic discharge. The volume resistivity attenuation of the insulating layer and other layers having electrical insulating properties does not exceed 20% under extreme industrial environments, thereby enabling adaptation to complex industrial conditions including high humidity and low temperatures.

It should be noted that, as used herein, terms such as “first” and “second” are only descriptive, and should not be construed as indicating or implying their relative importance or implicitly specifying the number of technical features indicated. Moreover, the terms “comprise”, “include” or any other variants thereof are intended to cover non-exclusive inclusion, such that a process, method, article, or apparatus that comprises a list of elements does not include only those elements, but may also include other elements not expressly listed or elements inherent to such process, method, article, or apparatus. In the absence of additional limitations, an element defined by the phrase “comprising a . . . ” does not exclude the presence of additional elements of the same type in a process, method, article, or apparatus that comprises the stated element.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A layered structure for electrostatic filtration of nanoscale particles, in sequence from outside to inside, comprising:
an antistatic protective layer;
an electrostatic adsorption layer;
an insulating layer;
a flexible electrode layer;
a skin-compatible waterproof layer; and
a power supply assembly;
wherein two poles of the power supply assembly are respectively connected to the electrostatic adsorption layer and the flexible electrode layer;
the antistatic protective layer, the electrostatic adsorption layer, the insulating layer, the flexible electrode layer and the skin-compatible waterproof layer are prepared through an in-situ polymerization and vacuum filtration integrated molding process, and there is no interlayer gap between any two adjacent layers of the antistatic protective layer, the electrostatic adsorption layer, the insulating layer, the flexible electrode layer and the skin-compatible waterproof layer;
the electrostatic adsorption layer is a composite porous membrane formed by reduced graphene oxide sheets and nitrogen-doped graphene quantum dots;
the reduced graphene oxide sheets are configured to be interlaced to construct a three-dimensional interconnected framework, and has a reduction degree of 70%-80%, while retaining some oxygen-containing functional groups comprising hydroxyl groups and epoxy groups;
the nitrogen-doped graphene quantum dots are embedded in a monodispersed state at surfaces, gaps and micropore edges of the reduced graphene oxide sheets, and are in-situ blended with the reduced graphene oxide sheets via I-a stacking;
the antistatic protective layer is a waterproof insulating polyvinylidene fluoride (PVDF) composite coating synergistically modified by 0.5 wt. % of nano-silica and 1 wt. % of a fluorocarbon waterproofing agent; and a surface of the antistatic protective layer is provided with micro-protrusions;
the insulating layer is a waterproof polyimide (PI) film or an electrospun polylactic acid (PLA) film, having a thickness of 1-2 μm and a microporosity of greater than or equal to 70%; and the insulating layer is bonded to the electrostatic adsorption layer and the flexible electrode layer;
the flexible electrode layer is a graphene-coated PI film or a carbon nanotube-coated PI film, and has a thickness of 1-1.2 μm; a middle area of the flexible electrode layer is arranged in a discontinuous pattern of dots or grids; and a continuous conductive region having a width of 5-8 mm is reserved at an edge of the flexible electrode layer; and
the skin-compatible waterproof layer is a waterproof cotton-blended composite film modified by 0.8 wt. % silicone waterproofing agent, and has a thickness of 2-3 μm, a volume resistivity greater than or equal to 10¹⁰ Ω·cm, and an air permeability greater than or equal to 300 mm/s under a pressure of 200 Pa.

2. The layered structure of claim 1, wherein the power supply assembly comprises a flexible thin-film battery, an overcurrent protection resistor, a Zener diode and a switch;
the flexible thin-film battery, the overcurrent protection resistor, the Zener diode and the switch are connected in series through wires;
a connection between the power supply assembly and the electrostatic adsorption layer is located in an edge region of a side of the electrostatic adsorption layer away from the insulating layer; and
a connection between the power supply assembly and the flexible electrode layer is located in the continuous conductive region.

3. The layered structure of any one of claims 1-2, wherein the layered structure is applied to a disposable industrial electrostatic dust-removal mask;
the disposable industrial electrostatic dust-removal mask, from outside to inside, sequentially comprises a protective fabric layer, the layered structure, a supporting mesh layer and a skin-compatible fabric layer;
the protective fabric layer is made of polyester fiber, and has a thickness of 5-8 μm;
the supporting mesh layer is made of a polyamide material, with a mesh aperture size of 100-200 μm;
the skin-compatible fabric layer is made of a cotton-blended material, and has a thickness of 3-5 μm;
the skin-compatible fabric layer is distributed in a face-contacting region of a base of the disposable industrial electrostatic dust-removal mask; and
a protruding non-face-contacting filtration cavity of the disposable industrial electrostatic dust-removal mask is provided with the protective fabric layer, the layered structure and the supporting mesh layer.

4. The layered structure of any one of claims 1-2, wherein the layered structure is prepared through steps of:
sequentially depositing the antistatic protective layer, the electrostatic adsorption layer, the insulating layer, the flexible electrode layer and the skin-compatible waterproof layer on a filter membrane through the in-situ polymerization and vacuum filtration integrated molding process at a vacuum degree ranging from −0.09 MPa to −0.08 MPa and a polymerization temperature of 58-62 °C for 1.5-2.5 h; and
the electrostatic adsorption layer is prefabricated via the following steps prior to the integrated molding process:
mixing a graphene oxide dispersion and nitrogen-doped graphene quantum dots at a weight ratio of 95:5 followed by ultrasonic dispersion for 25-35 min, pH adjustment to 6.3-6.7, addition of vitamin C as a reducing agent, and reduction reaction at 60 °C for 1.5-2.5 h, wherein a reduction degree is controlled to be 70-80%.

5. The layered structure of claim 1, wherein the electrostatic adsorption layer is a nanocarbon fiber-electrospun PVDF composite membrane, which is prepared through steps of:
blending nanocarbon fibers and a PVDF electret at a weight ratio of 1:9 followed by electrospinning at a spinning voltage of 18-22 kV, a flow rate of 0.8-1.2 mL/h and a collection distance of 15-20 cm to form the nanocarbon fiber-electrospun PVDF composite membrane having a thickness of 12-15 μm.
